(19) United States
(12) Patent Application Publication
(10) Pub. No.: US 2008/0114636 A1
(43) Pub. Date: May 15, 2008

(54) Smart Meetings Interactive Electronic Calendar

(76) Inventor: Thirumal R. Nellutla, Schaumburg (IL)

Correspondence Address: IBM CORPORATION (RUS);c/o Rudolf O Siegesmund Gordon & Rees, LLp, 2100 Ross Avenue, Suite 2800, DALLAS, TX, 75201, US

(21) Appl. No.: 11/558,011

(22) Filed: Nov. 9, 2006

(51) Int. Cl. G06Q 99/00

(52) U.S. Cl. 705/9

(57) ABSTRACT

The Smart Meetings Plug-in for automated calendaring software allows meeting invitees to add comments when accepting a meeting invitation so that all invitees to the meeting can see the comments in the calendar entry created by accepting the meeting invitation. When automated calendaring software sends an invitation to a first recipient and a second recipient on an automated calendaring system, the automated calendaring software creates a calendar entry for the first recipient and the second recipient in response to receiving an acceptance of the invitation. Responsive to receiving a comment from the first recipient, the Smart Meetings Plug-in adds the comment to the calendar entry for the first recipient, and also adds the comment to the calendar entry for the second recipient.

### FIELD OF THE INVENTION

The present invention relates generally to electronic calendaring methods, and relates specifically to posting comments in a calendar entry created by a meeting invitation so that the comments can be viewed by other invitees.

### BACKGROUND OF THE INVENTION

Existing automated calendaring software integrates e-mailed invitations with an electronic calendar. Software products such as MICROSOFT OUTLOOK and LOTUS NOTES provide automated calendaring software useful for scheduling meetings. Meetings include traditional face-to-face meetings, teleconferences, videoconferences, and online group chats. To schedule a meeting, a moderator sends an invitation via e-mail to a list of invitees. The invitation includes a date and time for the meeting, and can include other information such as location and comments added by the moderator. Invitees can either accept the invitation, reject the invitation, tentatively accept the invitation, or propose a new time. When an invitee accepts an invitation, the automated calendaring software automatically adds the meeting as an calendar entry in the invitee's personal calendar. When accepting an invitation, invitees can perform actions such as setting a reminder notification and adding personal comments to the calendar entry. The invitee's personal comments may relate to specific ideas, views, or discussion topics for the meeting. Whenever the time for the meeting arrives, the invitee can reference the personal comments to prepare for the meeting.

Difficulties arise scheduling team meetings in a large corporation because invitees work in different worksites or internal organizations. If key individuals cannot attend a meeting, the meeting may not accomplish the desired goals. If the meeting gets off-topic, the meeting may waste time. Because of the difficulty coordinating a convenient time for meetings, it is important to take advantage of a scheduled meeting by conducting the meeting in an efficient manner. The meeting should stay on topic and not be sidetracked by discussions that should be addressed in a different forum.

One way to help focus a meeting would be to arrange for invitees to share comments and ideas prior to the scheduled meeting. The shared comments could then be archived for future reference when creating an agenda, when preparing for the meeting, or when drafting meeting minutes. A need exists for an automated calendaring system that can distribute comments among meeting invitees.

### SUMMARY OF THE INVENTION

The Smart Meetings Plug-in for automated calendaring software allows meeting invitees to add comments when accepting a meeting invitation so that all invitees to the meeting can see the comments in the calendar entry created by accepting the meeting invitation. When automated calendaring software sends an invitation to a first recipient and a second recipient on an automated calendaring system, the automated calendaring software creates a calendar entry for the first recipient and the second recipient in response to receiving an acceptance of the invitation. Responsive to receiving a comment from the first recipient, the Smart Meetings Plug-in adds the comment to the calendar entry for the first recipient, and also adds the comment to the calendar entry for the second recipient.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is an exemplary computer network;

FIG. 2 describes programs and files in a memory on a computer;

FIG. 3 is a flowchart of a moderator component; and

FIG. 4 is a flowchart of an invitee component.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory. The term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Smart Meetings Plug-in”

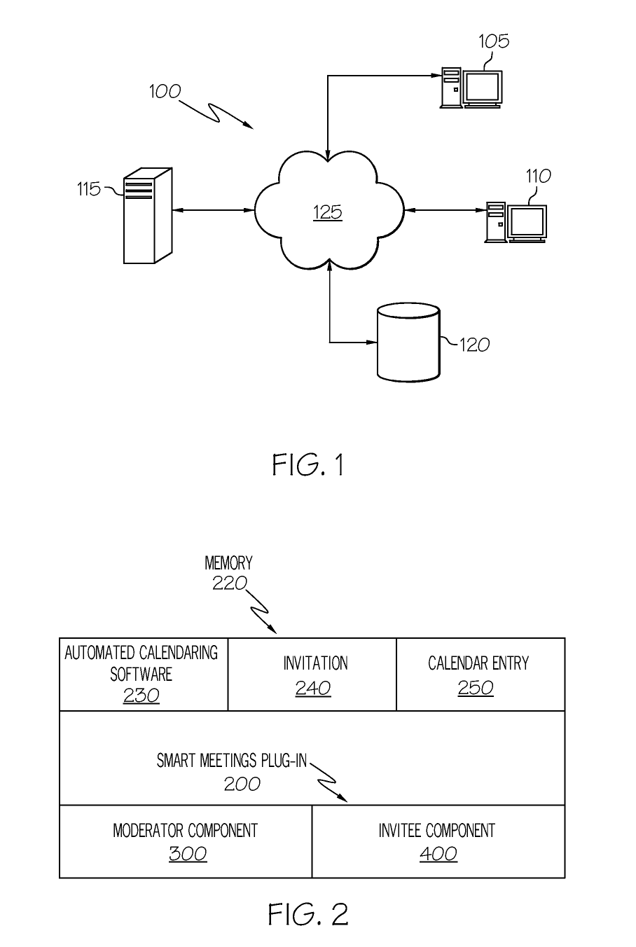

Additionally, the Smart Meetings Plug-in is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

Smart Meetings Plug-in 200 typically is stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Further, Smart Meetings Plug-in 200 may reside in more than one memory distributed across different computers, servers, logical partitions, or other hardware devices. The elements depicted in memory 220 may be located in or distributed across separate memories in any combination, and Smart Meetings Plug-in 200 may be adapted to identify, locate and access any of the elements and coordinate actions, if any, by the distributed elements. Thus, FIG. 2 is included merely as a descriptive expedient and does not necessarily reflect any particular physical embodiment of memory 220. As depicted in FIG. 2, though, memory 220 may include additional data and programs. Of particular import to Smart Meetings Plug-in 200, memory 220 may include Automated Calendaring Software 230, invitation 240, and calendar entry 250 with which Smart Meetings Plug-in 200 interacts. Invitation 240 is an e-mail meeting invitation file created by Automated Calendaring Software 230 and calendar entry 250 is created by Automated Calendaring Software 230 when invitation 240 is accepted. In a preferred embodiment, Automated Calendaring Software 230 operates on an exchange server, where e-mails, invitations, and calendar entries are stored in a centralized repository, and individual users access the exchange server to interact with their e-mails, invitations and calendars. In an exchange server, each invitees views invitation 240 and calendar entry 250 as if they each have a personal copy, but only one instance of invitation 240 and calendar entry 250 exists on the exchange server. Smart Meetings Plug-in 200 has two components. Moderator component 300 is used by a moderator when creating invitation 240 or editing calendar entry 250. Invitee component 400 is used by invitees when responding to invitation 240 or editing calendar entry 250.

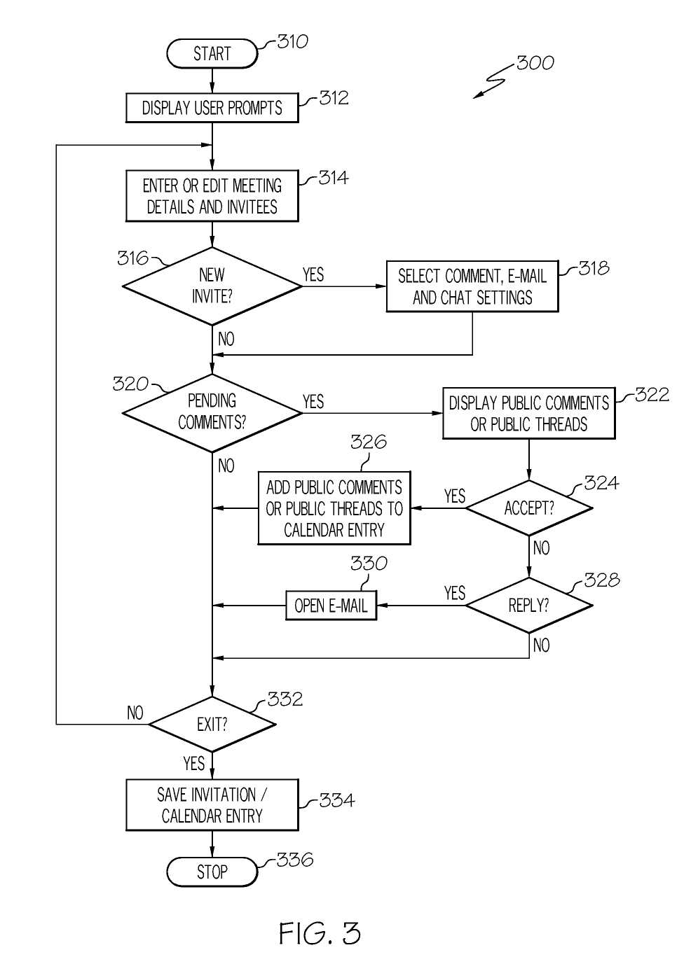

FIG. 3 shows moderator component 300 start (310) whenever a moderator creates meeting invitation 240 or edits calendar entry 250 with Automated Calendaring Software 230. Moderator component 300 displays user prompts (312) related to the actions described below. User prompts can include radio buttons, drop down menus, text fields, selectable icons, or check boxes. The moderator enters or edits meeting details such as date, time, location, and a list of invitees (314). If the moderator is creating a new instance of invitation 240 (316), the moderator can select whether to allow invitees to post public comments or public threads such as e-mails, or chat sessions to calendar entry 250, or if public comments and threads require review by the moderator before inclusion in calendar entry 250 (318). If there are pending public comments or public threads waiting for approval by the moderator (320) moderator component 330 displays the public comments or public threads (322). The moderator can choose whether to accept the public comments or public threads (324). If the moderator accepts the public comments or public threads at step 324, the public comments or public threads are added to calendar entry 250 (326). If the moderator rejects the public comments or public threads at step 324, the moderator can choose whether to reply to the originator of the public comment or public thread (328). If the moderator chooses to reply at step 328, moderator component 300 opens a new e-mail message (330); otherwise, moderator component proceeds to step 332. Moderator component 300 repeats steps 314-332 until the moderator chooses to exit (332). When the moderator exits moderator component 300, invitation 240 or calendar entry 250 is saved to memory 220 (334) and moderator component 300 stops (336). When the moderator saves a new instance of invitation 240, Automated Calendaring Software 230 sends a copy of invitations 240 to each invitee. When the moderator edits calendar entry 250, Automated Calendaring Software 230 updates calendar entry 250 for each invitee.

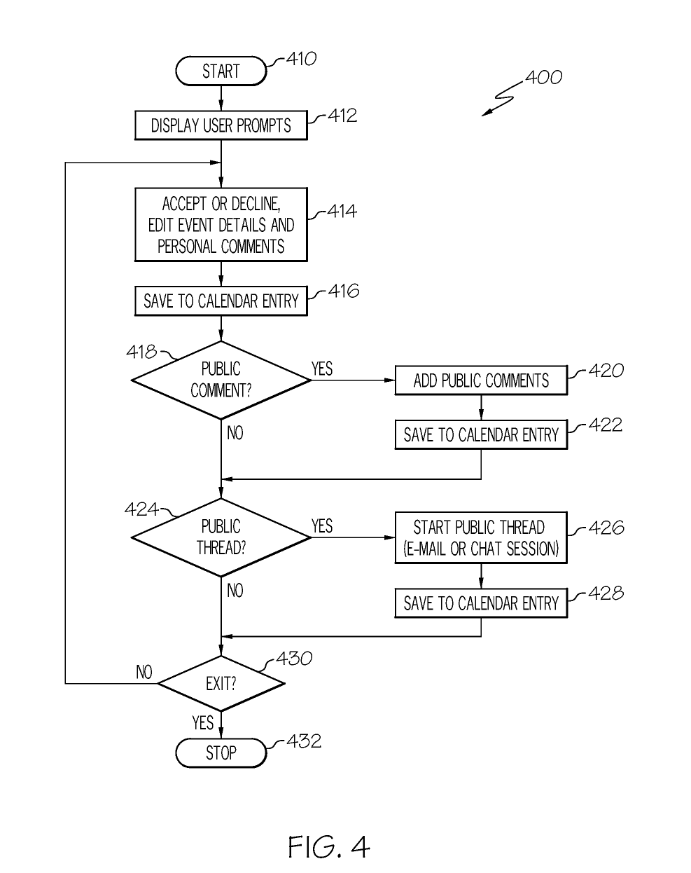

Referring to FIG. 4, invitee component 400 starts (410) when an invitee opens meeting invitation 240 or opens calendar entry 250 with Automated Calendaring Software 230. Invitee component 400 displays user prompts (412) related to the actions described below. User prompts can include radio buttons, drop down menus, text fields, selectable icons, or check boxes. The invitee can accept or decline invitation 240, and can edit personal details, such as setting a reminder notification or adding personal comments (414). In some embodiments of automated calendaring software 230, the invitee can also tentatively accept invitation 240 or can propose an alternate meeting time. Invitee component saves the invitee's response, personal details and person comments to calendar entry 250 (416). If the invitee wishes to add a public comment for all invitees (418), the invitee adds public comments (420) and invitee component 400 saves the comments to calendar entry 250 in memory 220 (422). Depending on the settings made by the moderator, the public comments may not appear on other invitees's copies of calendar entry 250 until the moderator accepts the public comments. If the invitee wishes to start a public thread, such as an e-mail or chat session related to the meeting with other invitees (424), the invitee starts a public thread such as an e-mail or chat session (426) and invitee component 400 saves the public thread to calendar entry 250 in memory 220 (428). Steps 424-428 also allow an invitee to participate in an existing public thread created by another invitee related to calendar entry 250. Depending on the settings made by the moderator, the public comments or public thread may not appear on other invitees's copies of calendar entry 250 until the moderator accepts the public comments or public thread. Invitee component 300 repeats steps 416-430 until the invitee chooses to exit (430). When the invitee exits component 400, invitee component 400 stops (432).

In a further embodiment, the invitee can post public comments or start a public thread with a subset of the other invitees. In this further embodiment, the public comment or public thread will only appear in the subset of other invitees invitation copies. In this further embodiment, the moderator may have further controls, such as the ability to review and approve the public comment or public thread, or to copy the public comment or public thread from the subset of invitees to all the other invitees.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for adding a comment to a calendar entry on an automated calendaring system, the computer implemented process comprising:
sending an invitation to a first recipient and a second recipient on an automated calendaring system;
responsive to receiving an acceptance to the invitation from the first recipient, creating a calendar entry for the first recipient based on the invitation;
responsive to receiving an acceptance to the invitation from the second recipient, creating a calendar entry for the second recipient based on the invitation;
responsive to receiving a comment from the first recipient, adding the comment to the calendar entry for the first recipient; and
responsive to receiving a comment from the first recipient, adding the comment to the calendar entry for the second recipient.

2. The computer implemented process of claim 1 wherein a moderator must approve the comment before adding the comment to the calendar entry for the second recipient.

3. The computer implemented process of claim 1 further comprising:
starting an e-mail thread related to the calendar entry for the first recipient;
adding the e-mail thread to the calendar entry for the first recipient; and
adding the e-mail thread to the calendar entry for the second recipient.

4. The computer implemented process of claim 3 wherein a moderator must approve the e-mail thread before adding the e-mail thread to the calendar entry for the second recipient.

5. The computer implemented process of claim 1 further comprising:
starting a chat session related to the calendar entry for the first recipient;
adding the chat session to the calendar entry for the first recipient; and
adding the chat session to the calendar entry intended for the second recipient.

6. The computer implemented process of claim 5 wherein a moderator must approve the chat session before adding the chat session to the calendar entry for the second recipient.

7. An apparatus for adding a comment to a calendar entry on an automated calendaring system, the apparatus comprising:
a processor;
a memory connected to the processor;
an automated calendaring system running in the memory;
an invitation in the memory created by the automated calendaring system intended for a first recipient and a second recipient; and
a smart meeting program in the memory operable to send an invitation to a first recipient and a second recipient on an automated calendaring system, responsive to receiving an acceptance to the invitation from the first recipient, create a calendar entry for the first recipient based on the invitation, responsive to receiving an acceptance to the invitation from the second recipient, create a calendar entry for the second recipient based on the invitation, responsive to receiving a comment from the first recipient, add the comment to the calendar entry for the first recipient, and responsive to receiving a comment from the first recipient, add the comment to the calendar entry for the second recipient.

8. The apparatus of claim 7 wherein the smart meeting program in the memory requires moderator approval of the comment before adding the comment to the calendar entry for the second recipient.

9. The apparatus of claim 7 wherein the smart meeting program in the memory is further operable to start an e-mail thread related to the calendar entry for the first recipient, add the e-mail thread to the calendar entry for the first recipient, and add the e-mail thread to the calendar entry for the second recipient.

10. The apparatus of claim 9 wherein the smart meeting program in the memory requires moderator approval of the e-mail thread before adding the e-mail thread to the calendar entry for the second recipient.

11. The apparatus of claim 7 wherein the smart meeting program in the memory is further operable to start a chat session related to the calendar entry for the first recipient, add the chat session to the calendar entry for the first recipient, and add the chat session to the calendar entry for the second recipient.

12. The apparatus of claim 11 wherein the smart meeting program in the memory requires moderator approval of the chat session before adding the chat session to the calendar entry for the second recipient.

13. A computer readable memory containing a plurality of instructions to cause a computer to add a comment to a calendar entry on an automated calendaring system, the plurality of instructions comprising:
a first instruction to send an invitation to a first recipient and a second recipient on an automated calendaring system;
responsive to receiving an acceptance to the invitation from the first recipient, a second instruction to create a calendar entry for the first recipient based on the invitation;
responsive to receiving an acceptance to the invitation from the second recipient, a third instruction to create a calendar entry for the second recipient based on the invitation;
responsive to receiving a comment from the first recipient, a fourth instruction add the comment to the calendar entry for the first recipient; and
responsive to receiving a comment from the first recipient, a fifth instruction to add the comment to the calendar entry for the second recipient.

14. The computer readable memory claim 13 wherein the fifth instruction requires moderator approval of the comment before adding the comment to the calendar entry for the second recipient.

15. The computer readable memory claim 13 further comprising:
a sixth instruction to start an e-mail thread related to the calendar entry for the first recipient;
a seventh instruction to add the e-mail thread to the calendar entry for the first recipient; and
an eighth instruction to add the e-mail thread to the calendar entry for the second recipient.

16. The computer readable memory claim 15 wherein the eighth instruction requires moderator approval of the e-mail thread before adding the e-mail thread to the calendar entry for the second recipient.

17. The computer readable memory claim 13 further comprising:
a sixth instruction to start a chat session related to the calendar entry for the first recipient;
a seventh instruction to add the chat session to the calendar entry for the first recipient; and
an eighth instruction to add the chat session to the calendar entry for the second recipient.

18. The computer readable memory claim 17 wherein the eighth instruction requires moderator approval of the chat session before adding the chat session thread to the calendar entry for the second recipient.
